(19) United States
(12) Patent Application Publication
(10) Pub. No.: US 2018/0115977 A1
(43) Pub. Date: Apr. 26, 2018

(54) WIRELESS COMMUNICATION SYSTEM, BASE STATION DEVICE, WIRELESS COMMUNICATION CONTROL DEVICE, AND WIRELESS COMMUNICATION CONTROL METHOD

(71) Applicant: FUJITSU LIMITED, Kawasaki-shi (JP)

(72) Inventors: Hiroshi Fujita, Yokosuka (JP); YUN WEN, Kawasaki (JP); Takayoshi Nakayama, Kawasaki (JP); Dai Kimura, Yokohama (JP)

(73) Assignee: FUJITSU LIMITED, Kawasaki-shi (JP)

(21) Appl. No.: 15/719,059

(22) Filed: Sep. 28, 2017

(30) Foreign Application Priority Data
Oct. 24, 2016 (JP) 2016-207686

(51) Int. Cl. H04W 72/08; H04W 24/08; H04W 24/10

(52) U.S. Cl. CPC H04W 72/085; H04W 24/08; H04W 88/08; H04W 72/082; H04W 24/10

(57) ABSTRACT

An other-channel received-power measurement unit of an access point measures a channel occupancy rate due to communication between the access point itself and a terminal connected to the access point itself in a communication channel. A communication-channel received-power measurement unit measures received powers from another access point using the communication channel and a terminal connected to the other access point. The other-channel received-power measurement unit measures received powers from another access point using a channel other than the communication channel and a terminal connected to the other access point. An interference-power calculation unit and an interference-occupancy-rate calculation unit of a control station device obtains an interference power and an interference occupancy rate between each pair among the access points, based on the channel occupancy rate, the first received power, and the second received power in each access point.

### CROSS-REFERENCE TO RELATED APPLICATION

This application is based upon and claims the benefit of priority of the prior Japanese Patent Application No. 2016-207686, filed on Oct. 24, 2016, the entire contents of which are incorporated herein by reference.

### FIELD

The embodiments discussed herein are related to a wireless communication system, a base station device, a wireless communication control device, and a wireless communication control method.

### BACKGROUND

Recently, wireless local area networks (LANs) in accordance with IEEE 802.11 standards have been widely used not only in companies and public spaces but also in ordinary households because of widespread use of high-performance wireless terminals such as notebook computers and smart phones that can be carried. Examples of the wireless LANs in accordance with IEEE 802.11 standards include a wireless LAN using a frequency band of 2.4 GHz and a wireless LAN using a frequency band of 5 GHz.

In the wireless LAN using the frequency band of 2.4 GHz, 13 channels are provided. However, when a plurality of channels are used at the same location, the channels need to be used such that spectra thereof do not overlap to avoid interference, and thus three channels or four channels under certain circumstances can be used at maximum. In the wireless LAN using the frequency band of 5 GHz, eight channels and 11 channels, and thus 19 channels in total are available.

With the widespread use of the wireless terminals, the number of access points (APs) that wireless communication systems have are continuously increasing. Accordingly, in some channels selected by an access point, influenced by a signal from another access point having a communication cell overlapping each other, throughput in the access point may decrease or throughput efficiency of the entire system may decrease.

In view of this, a control station is used that manages frequency channels of base station devices and determines which frequency band each access point uses. Each access point performs communication using a channel allocated by the control station. In this case, in order to perform wireless LAN channel allocation on each access point, the control station generates an interference matrix that represents an interference amount that is influence of interference in each access point from nearby access points and terminals subordinate to the nearby access points. The control station generates the interference matrix, using interference powers and channel occupancy rates of interference radio waves from nearby access points and terminals subordinate to the nearby access points in each access point. Each channel occupancy rate is a usage rate of wireless communication during a certain period of time, which equals to a traffic volume during a certain period of time that is the average of access rates to the channel of the corresponding wireless terminal.

The channels used for communication herein differ among the access points. Each access point scans all channels to measure the interference powers and the channel occupancy rates, and notifies the control station of the measurement results. In particular, in order to measure the channel occupancy rates in all channels, each access point repeats temporarily stopping communication and performing measurement while changing channels to be measured the same number of times as the number of the channels.

Examples of a method for scanning all channels to measure the channel occupancy rates include a conventional technique in which each access point has a circuit for power measurement in addition to a circuit for wireless communication and uses the circuit for power measurement to perform measurement at predetermined intervals. Examples of the method also include a conventional technique in which each access point stops communication at timing specified by a control station, changes channels to a designated one, and measures the channel occupancy rate.

[Patent Document 1] Japanese Laid-open Patent Publication No. 2013-115503

[Patent Document 2] Japanese Laid-open Patent Publication No. 2005-333510

### Non-Patent Documents

[Non-Patent Document 1] B. A. Hirantha, et al. “Network-Controlled Channel Allocation Scheme for IEEE 802.11 Wireless LANs: Experimental and Simulation Study” in Vehicular Technology Conference (VCT Spring), 2014 IEEE 79th, pp.1-5, 18-21 May 2014

[Non-Patent Document 2] Goto, Takyu, Fujii, Ohta, Sasamori, Handa, “The Measurement Evaluation of The Occupancy Ratio by USRP applied The Learning Measurement Method for Occupancy Ratio for Effective Use of Multi-Channel in Wireless LAN Environment”, IEICE SR workshop, SR2014-103, 2015

However, when all channels are scanned to measure the channel occupancy rates, each access point stops communication for a long period of time. Consequently, communication interruption that continues for a long period of time occurs in each access point, which may reduce the communication efficiency in each access point and the entire wireless communication system.

Even when the conventional technique of using the circuit for power measurement to perform measurement is used, it is difficult to measure interference powers and the channel occupancy rates of other channels during data transmission because transmitted radio waves may leak to the receiving side. In view of this, in order to measure interference powers and the channel occupancy rates of other channels, communication needs to be stopped, which may reduce the communication efficiency. Even when the conventional technique of stopping communication in accordance with designation by the control station to perform measurement is used, communication needs to be stopped for a long period of time to perform measurement, which may reduce the communication efficiency.

According to one aspect of the wireless communication system, the base station device, the wireless communication control device, and the wireless communication control method disclosed in the present application, an effect of being able to improve the communication efficiency can be obtained.

### SUMMARY

According to an aspect of an embodiment, a wireless communication system includes: a plurality of base station devices; and a wireless communication control device, wherein each of the base station devices includes: a channel-occupancy-rate measurement unit that measures a channel occupancy rate due to communication between the base station device itself and a terminal device connected to the base station device itself in a channel used for communication by the base station device itself; a first received-power measurement unit that measures a first received power from a first other base station device that uses for communication the channel used for communication by the base station device itself among the base station devices and from a first terminal device connected to the first other base station device; a second received-power measurement unit that measures a second received power from a second other base station device that uses for communication a channel other than the channel used for communication by the base station device itself among the base station devices and from a second terminal device connected to the second other base station device; and a notification unit that notifies the wireless communication control device of the channel occupancy rate, the first received power, and the second received power, and the wireless communication control device includes an interference-information calculation unit that obtains an interference power and an interference occupancy rate between each pair among the base station devices, based on the channel occupancy rate, the first received power, and the second received power of which the notification unit of each of the base station devices has notified the wireless communication control device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic configuration diagram of a wireless communication system;

FIG. 2 is a block diagram of an access point;

FIG. 3 is a block diagram of a control station device;

FIG. 4 is a flowchart of calculation of interference powers and interference occupancy rates;

FIG. 5 is a diagram of one example of an interference matrix;

FIG. 6 is a sequence diagram of channel allocation performed by a wireless communication system according to a first embodiment;

FIG. 7 is a diagram of one example of an interference-power matrix;

FIG. 8 is a diagram of one example of an interference-occupancy-rate matrix;

FIG. 9 is a hardware configuration diagram of the access point; and

FIG. 10 is a hardware configuration diagram of the control station device.

### DESCRIPTION OF EMBODIMENTS

Preferred embodiments of the present invention will be explained with reference to accompanying drawings. Note that the wireless communication system, the base station device, the wireless communication control device, and the wireless communication control method disclosed in the present application are not limited to those in the following embodiments.

### First Embodiment

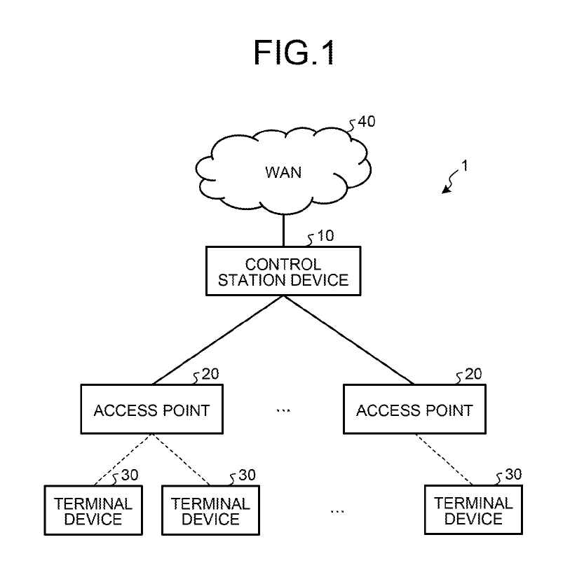

FIG. 1 is a schematic configuration diagram of the wireless communication system. This wireless communication system 1 includes a control station device 10 and a plurality of access points 20. To each access point 20, one or a plurality of terminal devices 30 are wirelessly connected.

The control station device 10 is connected to another network such as a wide area network (WAN) 40. The control station device 10 is also connected to the respective access points 20 that belong to the wireless communication system 1. The control station device 10 designates a channel used for wireless communication, and notifies each access point 20 of the channel. Furthermore, the control station device 10 relays communication between the access points 20 and relays communication between each access point 20 and the WAN 40. This control station device 10 is one example of a “wireless communication control device”.

Each access point 20 receives designation of the channel used for wireless communication from the control station device 10. The access point 20 then uses the designated channel to perform wireless communication with terminal devices 30 connected to the access point itself. Hereinafter, terminal devices 30 connected to a certain access point 20 are called “terminal devices 30 subordinate” to the access point 20. The access point 20 then transmits signals transmitted from the terminal devices 30 to the control station device 10. The access point 20 also transmits signals received from the control station device 10 to the terminal devices 30.

Each access point 20 can detect signals from and to the other access points 20. Each access point 20 can detect signals transmitted by terminal devices 30 subordinate to the other access points 20. However, when signal strengths of the signals transmitted from the other access points 20 and the terminal devices 30 subordinated to the other access points 20 are low at the access point 20, it is difficult for the access point 20 to appropriately detect the signals. Each access point 20 herein is one example of a “base station device”.

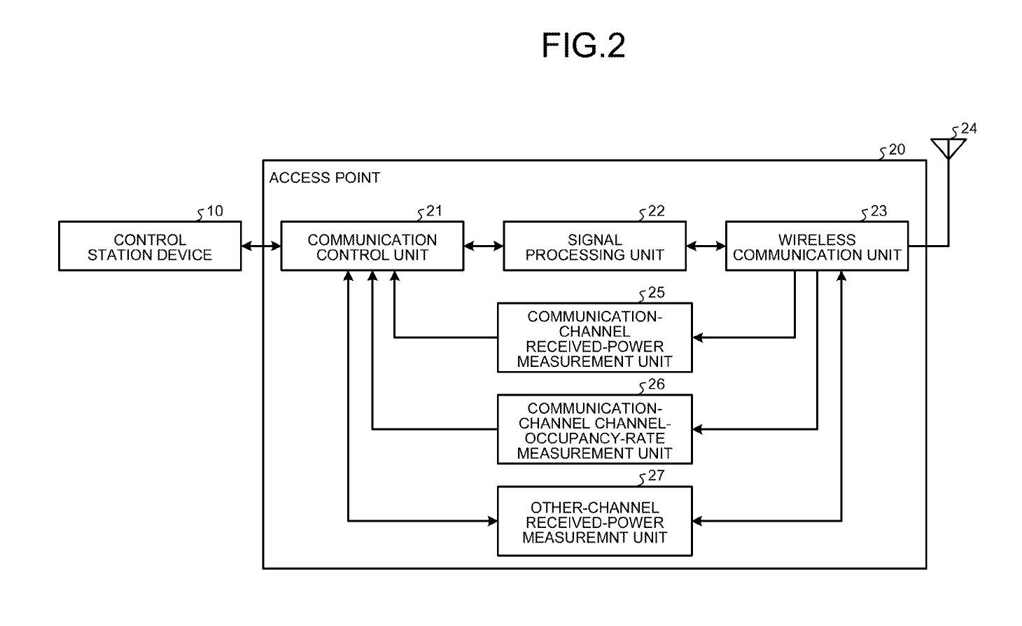

The following describes each access point 20 according to the present embodiment in detail with reference to FIG. 2. FIG. 2 is a block diagram of the access point. As depicted in FIG. 2, the access point 20 includes a communication control unit 21, a signal processing unit 22, a wireless communication unit 23, an antenna 24, a communication-channel received-power measurement unit 25, a communication-channel channel-occupancy-rate measurement unit 26, and an other-channel received-power measurement unit 27.

The communication control unit 21 receives a signal to be transmitted to each terminal device 30 subordinate to the access point itself from the control station device 10. The communication control unit 21 then outputs the received signal to the signal processing unit 22. The communication control unit 21 also receives an input of a signal transmitted from each terminal device 30 subordinate to the access point itself from the signal processing unit 22. The communication control unit 21 then outputs the acquired signal to the control station device 10.

The communication control unit 21 also receives information on a channel used for wireless communication from the control station device 10. The communication control unit 21 then notifies the signal processing unit 22 of this designated channel for wireless communication. Hereinafter, the channel used for wireless communication designated by the control station device 10 is called “communication channel”. Channels that can be used for wireless communication other than the communication channel are called “other channels”.

Furthermore, the communication control unit 21 receives information on timing for measuring received powers of the communication channel and the other channels from the control station device 10. The communication control unit 21 then identifies the other channels other than the designated communication channel. Subsequently, the communication control unit 21 notifies the other-channel received-power measurement unit 27 of information on the other channels and the timing for measuring the received powers of the other channels.

The communication control unit 21 also receives, from the communication-channel received-power measurement unit 25, inputs of received powers from the respective access points 20 using the same communication channel and received powers from the respective terminal devices 30 subordinate to the access points 20. Herein, a received power measured by using a signal transmitted from certain communication equipment is called “received power from the communication equipment”.

The communication control unit 21 also receives, from the communication-channel channel-occupancy-rate measurement unit 26, an input of a channel occupancy rate in the communication channel due to a signal transmitted from the access point itself to each terminal device 30 subordinate to the access point itself. Hereinafter, the channel occupancy rate due to a signal transmitted from the access point itself to a terminal device 30 is called “channel occupancy rate during transmission”. Furthermore, the communication control unit 21 receives, from the communication-channel channel-occupancy-rate measurement unit 26, an input of a channel occupancy rate in the communication channel due to a signal transmitted from each terminal device 30 subordinate to the access point itself to the access point itself. Hereinafter, the channel occupancy rate due to a signal transmitted from a terminal device 30 subordinate to the access point itself to the access point itself is called “channel occupancy rate during reception”.

Furthermore, the communication control unit 21 receives, from the other-channel received-power measurement unit 27, inputs of received powers from the respective access points 20 using the other channels and received powers from terminal devices 30 subordinate to the respective access points 20 using the other channels.

The communication control unit 21 then transmits, to the control station device 10, received powers from other access points 20 using the same communication channel in each access point 20 and received powers from terminal devices 30 subordinate to the other access points 20. Furthermore, the communication control unit 21 transmits, to the control station device 10, received powers from the respective access points 20 using the other channels and received powers from terminal devices 30 subordinate to the respective access points 20 using the other channels. In other words, the communication control unit 21 transmits, to the control station device 10, respective received powers from all of the other access points 20 in each access point 20 and respective received powers from all terminal devices 30 subordinate to the other access points 20. The communication control unit 21 also transmits, to the control station device 10, the channel occupancy rate in the communication channel during transmission to each terminal device 30 subordinate to the access point itself and the channel occupancy rate therein during reception from the terminal device. This communication control unit 21 is one example of a “notification unit”.

The signal processing unit 22 receives designation of the communication channel from the communication control unit 21. The signal processing unit 22 also receives, from the communication control unit 21, an input of a signal to be transmitted to each terminal device 30 connected to the access point itself. The signal processing unit 22 then performs a coding process and a modulation process on the acquired signal to generate a base band signal. Furthermore, the signal processing unit 22 maps the base band signal to a wireless resource in the communication channel. The signal processing unit 22 then performs digital-analog (DA) conversion on the generated base band signal. Subsequently, the signal processing unit 22 outputs the base band signal as an analog signal to the wireless communication unit 23.

The signal processing unit 22 also receives an input of a signal transmitted from each terminal device 30 connected to the access point itself from the wireless communication unit 23. The signal processing unit 22 performs analog-digital (AD) conversion on the acquired signal. Furthermore, the signal processing unit 22 performs a demodulation process and a decoding process on the digitized signal. The signal processing unit 22 then outputs the resulting signal after these processes to the communication control unit 21.

The wireless communication unit 23 receives, from the signal processing unit 22, an input of a signal to be transmitted to each terminal device 30 connected to the access point itself. The wireless communication unit 23 then performs modulation on the acquired signal, and increases the amplitude thereof. The wireless communication unit 23 then transmits the signal thus processed to the terminal device 30 via the antenna 24, using the communication channel.

The wireless communication unit 23 also receives a signal transmitted via the antenna 24 from each terminal device 30 connected to the access point itself, using the communication channel. The wireless communication unit 23 then demodulates the received signal to generate a base band signal. Subsequently, the wireless communication unit 23 outputs the generated base band signal to the signal processing unit 22.

Furthermore, the wireless communication unit 23 receives instructions to change channels at the measurement timing specified by the control station device 10 from the other-channel received-power measurement unit 27. In accordance with the instructions to change channels, the wireless communication unit 23 sequentially changes the channel used for communication to other channels that the access point itself can use one after another. Using the other channels thus changed, the wireless communication unit 23 receives signals in an amount to be used for measuring received powers, and outputs the received signals to the other-channel received-power measurement unit 27. In this manner, the wireless communication unit 23 only needs to receive signals in an amount to be used for measuring the received signals, using the respective other channels, and does not receive signals in an amount to be used for measuring channel occupancy rates. This can reduce a period of time during which the communication channel is stopped.

The communication-channel received-power measurement unit 25 acquires a signal received over the communication channel by the wireless communication unit 23. The communication-channel received-power measurement unit 25 then measures a received power for each of other access points 20 using the same communication channel for communication and terminal devices 30 subordinate to the other access points 20. The communication-channel received-power measurement unit 25 then outputs the measured received power for each of the other access points 20 and the terminal devices 30 of the other access points 20 to the communication control unit 21. This communication-channel received-power measurement unit 25 is one example of a “first received-power measurement unit”.

In regular communication with each terminal device 30 using the communication channel, the communication-channel channel-occupancy-rate measurement unit 26 measures the channel occupancy rate of a signal transmitted over the communication channel by the wireless communication unit 23 to obtain the channel occupancy rate during transmission. In regular communication with each terminal device 30 using the communication channel, the communication-channel channel-occupancy-rate measurement unit 26 also measures the channel occupancy rate of a signal received over the communication channel by the wireless communication unit 23 for each subordinate terminal device 30 to obtain the channel occupancy rate during reception for each subordinate terminal device 30. The communication-channel channel-occupancy-rate measurement unit 26 then outputs the channel occupancy rate during transmission and the channel occupancy rate during reception thus obtained for each terminal device 30 to the communication control unit 21. This communication-channel channel-occupancy-rate measurement unit 26 is one example of a “channel-occupancy-rate measurement unit”.

The other-channel received-power measurement unit 27 receives information on the other channels and timing for measuring received powers of the other channels from the communication control unit 21. The other-channel received-power measurement unit 27 then instructs the wireless communication unit 23 to sequentially change the channel to the other channels at the specified measurement timing. The other-channel received-power measurement unit 27 then acquires the signals received by the wireless communication unit 23 using the other channels sequentially changed. The other-channel received-power measurement unit 27 then obtains a received power for each of access points 20 using the other channels and terminal devices 30 subordinate to the access points 20 using the other channels. The other-channel received-power measurement unit 27 then outputs the received powers of the access points 20 using the other channels and the terminal devices 30 subordinate to the access points 20 to the communication control unit 21. This other-channel received-power measurement unit 27 is one example of a “second received-power measurement unit”.

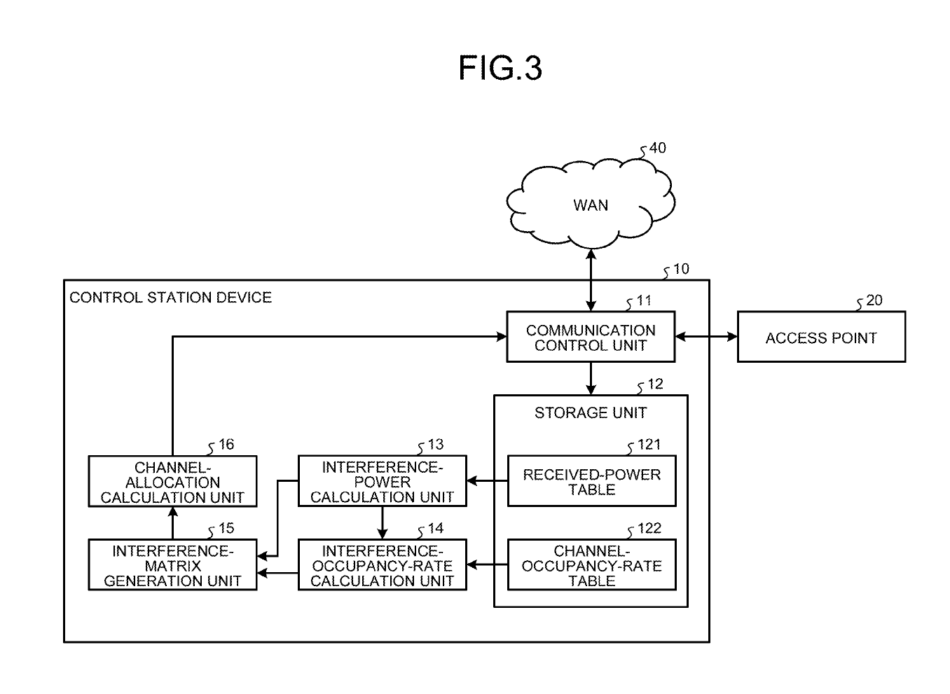

The following describes the control station device 10 in detail with reference to FIG. 3. FIG. 3 is a block diagram of the control station device. As depicted in FIG. 3, the control station device 10 includes a communication control unit 11, a storage unit 12, an interference-power calculation unit 13, an interference-occupancy-rate calculation unit 14, an interference-matrix generation unit 15, and a channel-allocation calculation unit 16.

The communication control unit 11 receives a signal to be transmitted to each terminal device 30 from the WAN 40. The communication control unit 11 then checks a destination of the signal, and transmits the signal to an access point 20 connected to a terminal device 30 that corresponds to the destination.

The communication control unit 11 also receives a signal transmitted from each terminal device 30 from an access point 20. The communication control unit 11 then checks a destination of the signal, and transmits the signal to another access point 20 or the WAN 40 on the basis of the destination.

The communication control unit 11 receives, from each access point 20, respective received powers from all of the other access points 20 and respective received powers from all terminal devices 30 in each access point 20. The communication control unit 11 then registers the respective received powers thus received in a received-power table 121 in the storage unit 12.

The communication control unit 11 also receives, from each access point 20, the channel occupancy rate during transmission to each subordinate terminal device 30 and the channel occupancy rate in the communication channel during reception from the terminal device in each access point 20. The communication control unit 11 then registers, in a channel-occupancy-rate table 122 in the storage unit 12, the channel occupancy rate in the communication channel during transmission to each subordinate terminal device 30 and the channel occupancy rate therein during reception from the terminal device in each access point 20.

The communication control unit 11 also receives an input of information on a channel allocated to each access point 20 from the channel-allocation calculation unit 16. The communication control unit 11 transmits the information on a channel allocated to each access point 20 to the corresponding access point 20. This communication control unit 11 is one example of an “information receiving unit”.

The storage unit 12 is a storage device such as a memory. The storage unit 12 has the received-power table 121 in which received powers from the other access points 20 and received powers from the terminal devices 30 in the access point 20 are registered. The storage unit 12 also has the channel-occupancy-rate table 122 in which the channel occupancy rate in the communication channel during transmission to each subordinate terminal device 30 and the channel occupancy rate therein during reception from the terminal device in each access point 20 are registered.

The interference-power calculation unit 13 acquires, from the received-power table 121, the received powers from the other access points 20 and the received powers of the terminal devices 30 in each access point 20. The interference-power calculation unit 13 stores therein in advance a power threshold for determining that interference occurs. The interference-power calculation unit 13 then selects, for each access point 20, another access point 20 and a terminal device 30 the received powers of which are equal to or higher than the power threshold. Hereinafter, an access point 20 and a terminal device 30 that are selected by the interference-power calculation unit 13 are called “selected access point 20” and “selected terminal device 30”.

The interference-power calculation unit 13 notifies the interference-occupancy-rate calculation unit 14 of information on an access point 20 and a terminal device 30 that are selected for each access point 20. Furthermore, the interference-power calculation unit 13 outputs, to the interference-matrix generation unit 15, a received power from the selected access point 20 and a received power of the selected terminal device 30 in each access point 20.

Subsequently, the interference-power calculation unit 13 calculates, for each access point 20, an interference power from the selected access point 20 in the access point 20. Herein, calculation of the interference power performed by the interference-power calculation unit 13 will be described as an example in a certain access point 20. The term “selected access point 20” herein denotes another access point 20 that is selected with respect to the certain access point 20. The term “terminal device 30” herein denotes a terminal device 30 that is selected with respect to the certain access point 20.

The interference-power calculation unit 13 adds a received power from a selected access point 20 in the certain access point 20 and a received power from a selected terminal device 30 subordinate to another access point 20 in the certain access point 20. The interference-power calculation unit 13 then sets the resulting sum as an interference power between the certain access point 20 and the other access point 20.

The interference-power calculation unit 13 performs this calculation of interference power for all access points 20. Subsequently, the interference-power calculation unit 13 outputs information on calculated interference powers between the respective access points 20 and the other access points 20 to the interference-matrix generation unit 15.

When the number of the respective access points 20 is N, numbers from #1 to #N are assigned to the respective access points 20, and the respective access points 20 are denoted by the access points #1 to N. Furthermore, let a terminal device #k (k is a natural number of one or more) be a terminal device 30 connected to another access point #j. Let P_{AP}(i, j) be a received power from the other access point #j in an access point #i in this case, and let P_{STA} (i, j, k) be a received power from the terminal device #k connected to the access point #j in the access point #i. In this case, the interference-power calculation unit 13 calculates an interference power from the access point #j in the access point #i as P_{AP}(i, j)+ΣP_{STA}(i, j, k). When a threshold of the received power is Pth, received powers of both P_{AP}(i, j) and P_{STA}(i, j, k) are used that are equal to or higher than Pth.

The interference-occupancy-rate calculation unit 14 acquires, from the channel-occupancy-rate table 122, the channel occupancy rate in the communication channel during transmission to each subordinate terminal device 30 and the channel occupancy rate therein during reception from the terminal device in each access point 20. Furthermore, the interference-occupancy-rate calculation unit 14 receives, from the interference-power calculation unit 13, an input of information on an access point 20 and a terminal device 30 selected for each access point 20. The interference-occupancy-rate calculation unit 14 then outputs, to the interference-matrix generation unit 15, the channel occupancy rate in the communication channel during transmission to each subordinate terminal device 30 and the channel occupancy rate therein during reception from the terminal device in each access point 20.

Subsequently, the interference-occupancy-rate calculation unit 14 calculates, for each access point 20, an interference occupancy rate from another access point 20 selected in the access point 20. Herein, calculation of the interference power performed by the interference-occupancy-rate calculation unit 14 will be described as an example in a certain access point 20.

The interference-occupancy-rate calculation unit 14 adds the channel occupancy rate during transmission to another access point 20 in the certain access point 20 and the channel occupancy rate during reception from a terminal device 30 subordinate to the other access point 20 in the other access point 20. The interference-occupancy-rate calculation unit 14 then sets the resulting sum as an interference occupancy rate from the other access point 20 in the certain access point 20.

The interference-occupancy-rate calculation unit 14 performs this calculation of interference occupancy rate for all access points 20. Subsequently, the interference-occupancy-rate calculation unit 14 outputs information on calculated interference occupancy rates from the other access points 20 in the respective access points 20 to the interference-matrix generation unit 15.

For example, let an access point #j be another access point 20 with respect to an access point #i in this case. Let α_{AP}(j) be a channel occupancy rate during transmission to the other access point #j, and let α_{STA}(j, k) be a channel occupancy rate during reception from a connected terminal device #k in the access point #j. In this case, the interference-occupancy-rate calculation unit 14 calculates an interference occupancy rate from the access point #j in the access point #i as α_{AP}(j)+Σα_{STA}(j, k). Note that, hereinafter, the channel occupancy rate α_{AP}(j) during transmission to the other access point #j that is used as an interference occupancy rate in the access point #i is denoted by α(i, j). The channel occupancy rate α_{STA}(j, k) during reception from the other access point #j that is used as an interference occupancy rate in the access point #i is denoted by α_{STA}(i, j, k). In other words, the interference-occupancy-rate calculation unit 14 calculates an interference occupancy rate from the access point #j in the access point #i as α_{AP}(i, j)+Σα_{STA}(i, j, k). Herein, for α_{AP}(i, j) and Σα_{STA}(i, j, k), channel occupancy rates with respect to the access point #j and the terminal device #k that make the P_{AP}(i, j) and P_{STA}(i, j, k) equal to or higher than Pth are used.

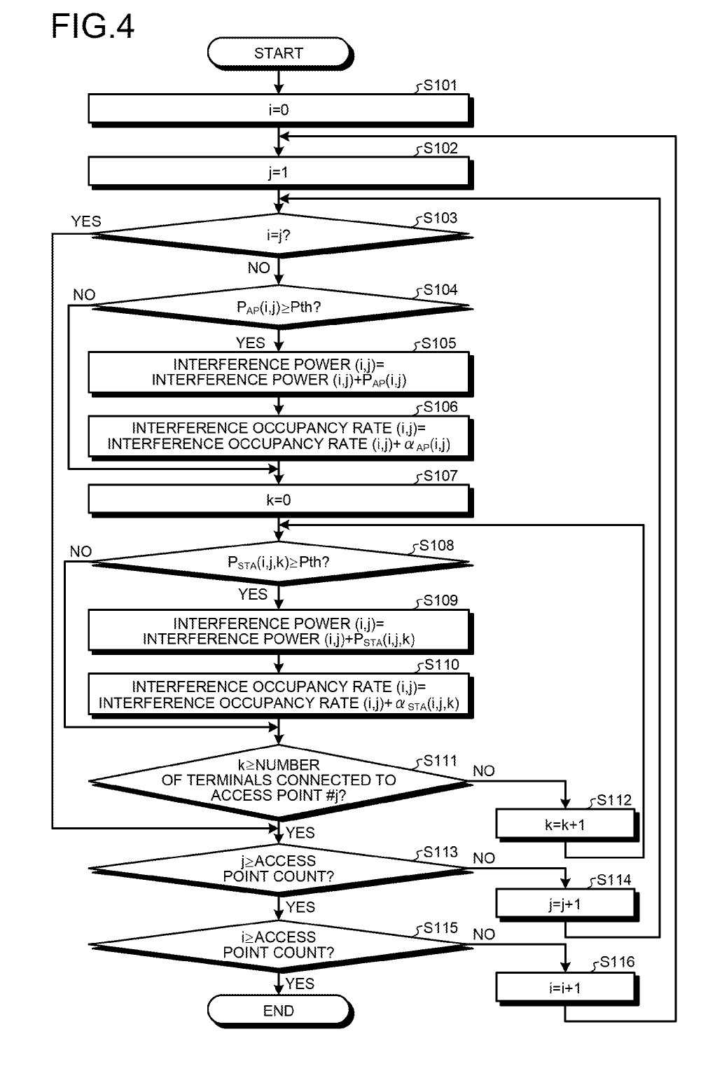

The following describes calculation of interference powers and interference occupancy rates in detail with reference to FIG. 4. FIG. 4 is a flowchart of calculation of the interference powers and the interference occupancy rates.

The interference-power calculation unit 13 and the interference-occupancy-rate calculation unit 14 set the number i of the access point #i to zero (step S101).

Subsequently, the interference-power calculation unit 13 and the interference-occupancy-rate calculation unit 14 set the number j of the access point #j to one (step S102).

Subsequently, the interference-power calculation unit 13 determines whether i=j (step S103). If i=j (Yes at step S103), the interference-power calculation unit 13 proceeds to step S113.

If i≠j (No at step S103), the interference-power calculation unit 13 determines whether P_{AP}(i, j) is equal to or higher than the threshold Pth (step S104). If P_{AP}(i, j) is lower than the threshold Pth (No at step S104), the interference-power calculation unit 13 and the interference-occupancy-rate calculation unit 14 proceed to step S107.

If P_{AP}(i, j) is equal to or higher than the threshold Pth (Yes at step S104), the interference-power calculation unit 13 sets the sum of the interference power (i, j) and P_{AP}(i, j) as a new interference power (i, j) (step S105). Herein, the initial value of the interference power (i, j) is zero.

The interference-occupancy-rate calculation unit 14 also sets the sum of the interference occupancy rate (i, j) and α_{AP}(i, j) as a new interference occupancy rate (i, j) (step S106). Herein, the initial value of the interference occupancy rate (i, j) is zero.

Subsequently, the interference-power calculation unit 13 and the interference-occupancy-rate calculation unit 14 sets the number k of the terminal device #k connected to the access point #j to zero (step S107).

The interference-power calculation unit 13 determines whether P_{STA}(i, j, k) is equal to or higher than the threshold Pth (step S108). If P_{STA}(i, j, k) is lower than the threshold Pth (No at step S108), the interference-power calculation unit 13 and the interference-occupancy-rate calculation unit 14 proceed to step S111.

If P_{STA}(i, j, k) is equal to or higher than the threshold Pth (Yes at step S108), the interference-power calculation unit 13 sets the sum of the interference power (i, j) and P_{STA}(i, j, k) as a new interference power (i, j) (step S109).

The interference-occupancy-rate calculation unit 14 also sets the sum of the interference occupancy rate (i, j) and α_{STA}(i, j, k) as a new interference occupancy rate (i, j) (step S110).

Subsequently, the interference-power calculation unit 13 and the interference-occupancy-rate calculation unit 14 determine whether k is equal to or larger than a connected terminal count that is the number of terminal devices 30 connected to the access point #j (step S111). If k is smaller than the connected terminal count to the access point #j (No at step S111), the interference-power calculation unit 13 and the interference-occupancy-rate calculation unit 14 increment k by one (step S112), and return to step S108.

If k is equal to or larger than the connected terminal count to the access point #j (Yes at step S111), the interference-power calculation unit 13 and the interference-occupancy-rate calculation unit 14 determine whether j is equal to or larger than an access point count (step S113). The access point count herein is the total number of access points 20 that belong to the wireless communication system 1. If j is smaller than the access point count (No at step S113), the interference-power calculation unit 13 and the interference-occupancy-rate calculation unit 14 increment j by one (step S114), and return to step S103.

If j is equal to or larger than the access point count (Yes at step S113), the interference-power calculation unit 13 and the interference-occupancy-rate calculation unit 14 determine whether i is equal to or larger than the access point count (step S115).

If i is smaller than the access point count (No at step S115), the interference-power calculation unit 13 and the interference-occupancy-rate calculation unit 14 increment i by one (step S116), and return to step S102. If i is equal to or larger than the access point count (Yes at step S115), the interference-power calculation unit 13 and the interference-occupancy-rate calculation unit 14 end the calculation of the interference powers and the interference occupancy rates.

This interference-power calculation unit 13 and this interference-occupancy-rate calculation unit 14 are one example of an “interference-information calculation unit”.

The interference-matrix generation unit 15 receives inputs of received powers from the other access points 20 and the terminal devices 30 over the communication channel in each access point 20. In addition, the interference-matrix generation unit 15 receives inputs of received powers from the other access points 20 and the terminal devices 30 connected to the other access points 20 over the other channels in each access point 20. Furthermore, the interference-matrix generation unit 15 receives, from the interference-power calculation unit 13, an input of information on interference powers from the other access points 20 in each access point 20.

The interference-matrix generation unit 15 receives inputs of a channel occupancy rate during transmission and a channel occupancy rate during reception in each access point 20. Furthermore, the interference-matrix generation unit 15 receives, from the interference-occupancy-rate calculation unit 14, an input of information on interference occupancy rates from the other access points 20 in each access point 20.

The interference-matrix generation unit 15 then obtains an interference matrix for each access point 20 from the acquired information on interference powers and interference occupancy rates. In the present embodiment, the interference-matrix generation unit 15 generates the matrix using as an element the sum of values obtained by assigning weights of received powers to the interference occupancy rates between each access point 20 and the other access points 20. For example, when an ij component of this interference matrix I is denoted by Iᵢⱼ, the interference-matrix generation unit 15 calculates Iᵢⱼ=P_{AP}(i, j)*α_{AP}(i, j)+Σ(P_{STA}(i, j, k)*α_{STA}(i, j, k)). Herein, for all of P_{AP}(i, j), α_{AP}(i, j), P_{STA}(i, j, k), and α_{STA}(i, j, k), values that make P_{AP}(i, j) and P_{STA}(i, j, k) equal to or higher than Pth with respect to the access point #j and the terminal device #k are used.

Alternatively, the following equation can be used as the interference-matrix for channel-allocation focusing on a traffic volume. The interference-matrix generation unit 15 calculates an interference matrix, Iᵢⱼ=f(P_{AP}(i, j))*U(i, j)*α_{AP}(i, j)+Σ(f (P_{STA}(i, j, k))*U(i, j)*α_{STA}(i, j, k)) where, P_{AP}(i, j) and α_{AP}(i, j) represents received power and channel-occupancy-rate, respectively, between the access points #i and #j; f(x) is a function with a value 1 if x≥Pth, and if not, a value 0; U(i, j) has a value 1 when the access points #i and #j use the same channel, and a value 0 when the access points #i and #j use different channels, i.e., U(i, j) varies depending on channel-allocation patterns; and P_{STA}(i, j, k) and α_{STA}(i, j, k) represents received power from the terminal #k subordinate to the access point #j in the access point #i, and channel-occupancy-rate of the terminal #k subordinate to the access point #j in the access point #i, respectively.

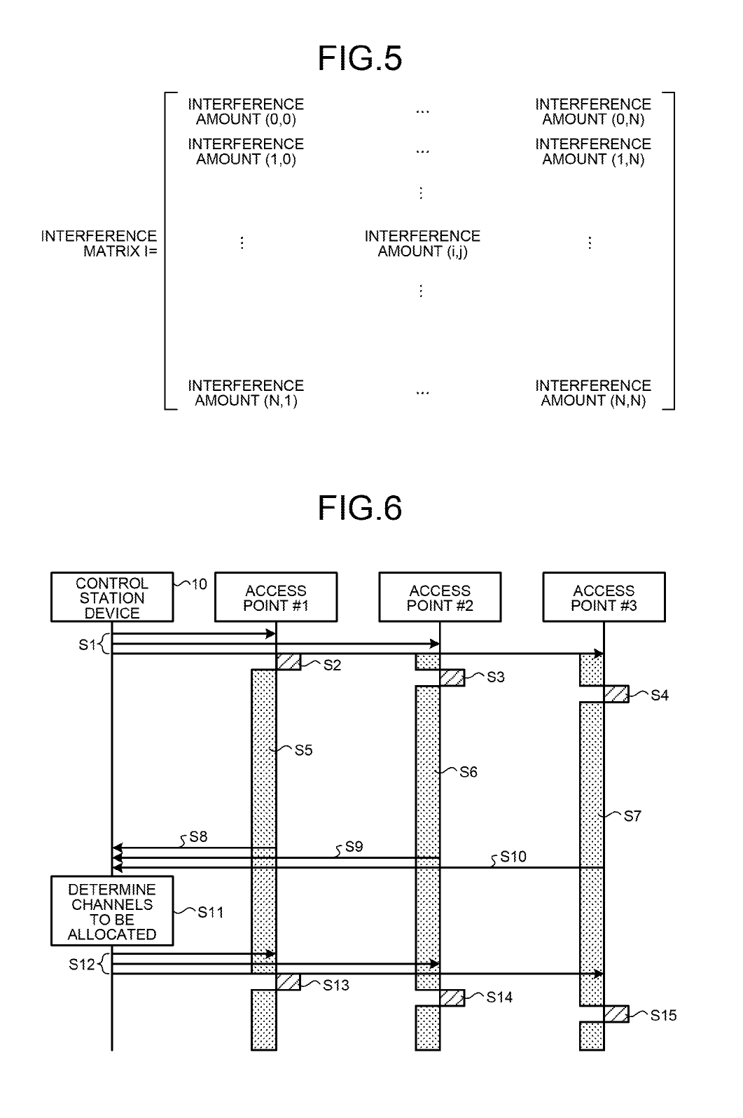

For example, the interference-matrix generation unit 15 obtains the interference matrix I depicted in FIG. 5. FIG. 5 is a diagram of one example of the interference matrix. The interference amount (i, j) in the interference matrix I corresponds to the ij component of the interference matrix I obtained by the interference-matrix generation unit 15. Specifically, the interference amount (i, j) corresponds to a period of time occupied by communication with the access point #j in the access point #i.

The interference-matrix generation unit 15 then outputs the interference matrix having the calculated ij component to the channel-allocation calculation unit 16.

The channel-allocation calculation unit 16 receives an input of the interference matrix from the interference-matrix generation unit 15. The channel-allocation calculation unit 16 then determines a communication channel for each access point 20, using the acquired interference matrix. Subsequently, the channel-allocation calculation unit 16 outputs information on the determined communication channel for each access point 20 to the communication control unit 11. In the present embodiment, the channel-allocation calculation unit 16 prepares combinations of each access point 20 and each channel, and searches a combination that can achieve the minimum interference amount, thereby determining the communication channel for each access point 20. The following briefly describes a method of determining the communication channel.

The channel-allocation calculation unit 16 calculates the sum for each row of the interference matrix. Subsequently, the channel-allocation calculation unit 16 selects, as a first allocation candidate access point, an access point 20 in the first column in a row in which the maximum sum is found. The channel-allocation calculation unit 16 then allocates an allocatable channel to the first allocation candidate access point. Subsequently, the channel-allocation calculation unit 16 selects, as a second allocation candidate access point, an access point 20 in the first column in a row in which the second largest sum is found. The channel-allocation calculation unit 16 then allocates an allocatable channel to the second allocation candidate access point. Subsequently, the channel-allocation calculation unit 16 calculates an intra-system interference amount for each combination of a channel from an access point 20 to which the channel has been allocated. For example, when the first allocation candidate access point and the second allocation candidate access point to both of which allocation has already been made use the same channel, the channel-allocation calculation unit 16 obtains the intra-system interference amount as follows.

Specifically, the channel-allocation calculation unit 16 sets, as the intra-system interference amount, an element Iᵢⱼ of the interference matrix in which the access point #i is the first allocation candidate access point and the access point #j is the second allocation candidate access point. When the first allocation candidate access point and the second allocation candidate access point to both of which allocation has already been made use different channels, the channel-allocation calculation unit 16 sets the intra-system interference amount to zero.

Subsequently, the channel-allocation calculation unit 16 selects, as a third allocation candidate access point, an access point 20 in the first column in a row in which the third largest sum is found. The channel-allocation calculation unit 16 then allocates an allocatable channel to the third allocation candidate access point. At this time, if the number of combinations of the allocation candidate access point and the channel is significantly large, the channel-allocation calculation unit 16 leaves the combinations in each of which the intra-system interference amount is small and the corresponding channel has already been allocated unchanged, and prepares remaining combinations of each access point 20 and each channel. In this manner, the channel-allocation calculation unit 16 calculates an intra-system interference amount for each combination of an allocation candidate access point and an allocatable channel. When having allocated channels to all access points 20, the channel-allocation calculation unit 16 obtains a combination of an access point 20 and a channel in which the intra-system interference amount is minimum. The channel-allocation calculation unit 16 sets, as a communication channel for each access point 20, the channel in the combination in which the intra-system interference amount is minimum.

However, the method for determining the communication channel is not limited to this. The channel-allocation calculation unit 16 may use another method that is a method in which an interference matrix is used to allocate a channel to each access point 20. This channel-allocation calculation unit 16 is one example of a “channel allocation unit”.

The following describes a processing flow of channel allocation performed by the wireless communication system 1 according to the present embodiment with reference to FIG. 6. FIG. 6 is a sequence diagram of channel allocation performed by the wireless communication system according to the first embodiment. Herein, a case in which access points #1 to #3 exist as access points 20 will be described.

The control station device 10 notifies the access points #1 to #3 of the corresponding communication channels, and also instructs the access points of measurement timing of received powers (step S1). The measurement timing of received powers is timing at which each of the access points #1 to #3 measures received powers from the other access points 20 over the corresponding communication channel. Since received powers are measured over the respective communication channels, the measurement timings are different timings so as not to overlap each other. The access points #1 to #3 receives notifications of the corresponding communication channels and instructions of the corresponding measurement timings of received powers from the control station device 10.

The access point #1 sequentially changes the communication channel to the communication channels of the access points #2 and #3 at the specified measurement timings to measure received powers over the corresponding channels (step S2). Because measurement of received powers can be performed within a short period of time, influence of changing of channels at this step exerted on the communication efficiency is small.

The access point #2 sequentially changes the communication channel to the communication channels of the access points #1 and #3 at the specified measurement timings to measure received powers over the corresponding channels (step S3).

The access point #3 sequentially changes the communication channel to the communication channels of the access points #1 and #2 at the specified measurement timings to measure received powers over the corresponding channels (step S4).

Furthermore, the access point #1 uses the allocated communication channel to perform communication during a period of time other than the measurement timings. During this period, the access point #1 measures received powers from an access point 20 using the same channel and terminal devices 30 connected to the access point #1. Furthermore, during this period, the access point #1 measures the channel occupancy rate during transmission and the channel occupancy rate during reception (step S5).

In the same manner, the access point #2 uses the allocated communication channel to perform communication during a period of time other than the measurement timings. During this period, the access point #2 measures received powers from an access point 20 using the same channel and terminal devices 30 connected to the access point #2. Furthermore, during this period, the access point #2 measures the channel occupancy rate during transmission and the channel occupancy rate during reception (step S6).

In the same manner, the access point #3 uses the allocated communication channel to perform communication during a period of time other than the measurement timings. During this period, the access point #3 measures received powers from an access point 20 using the same channel and terminal devices 30 connected to the access point #3. Furthermore, during this period, the access point #3 measures the channel occupancy rate during transmission and the channel occupancy rate during reception (step S7).

The access point #1 then transmits the received powers over the communication channel, the received powers over the other channels, the channel occupancy rate in the communication channel during transmission, and the channel occupancy rate therein during reception as measurement results to the control station device 10 (step S8).

In the same manner, the access point #2 transmits the received powers over the communication channel, the received powers over the other channels, the channel occupancy rate in the communication channel during transmission, and the channel occupancy rate therein during reception as measurement results to the control station device 10 (step S9).

In the same manner, the access point #3 transmits the received powers over the communication channel, the received powers over the other channels, the channel occupancy rate in the communication channel during transmission, and the channel occupancy rate therein during reception as measurement results to the control station device 10 (step S10).

The control station device 10 receives the measurement results of the received powers and the channel occupancy rates from the access points #1 to #3. Subsequently, the control station device 10 prepares an interference matrix, based on the received powers and the channel occupancy rates thus received. Using the prepared interference matrix, the control station device 10 determines channels to be allocated to the access points #1 to #3 (step S11).

The control station device 10 then notifies the access points #1 to #3 of the corresponding communication channels (step S12).

Subsequently, the access points #1 to #3 measure received powers at the specified measurement timings, and use communication over the communication channels to measure received powers and channel occupancy rates (steps S13 to S15). Subsequently, the control station device 10 and the access points #1 to #3 repeat notification of measurement results, allocation of channels, and measurement of received powers and channel occupancy rates.

As described in the foregoing, in the wireless communication system according to the present embodiment, each access point measures received powers over the communication channel of the access point itself, the channel occupancy rate therein, and received powers over the other channels, and transmits the measurement results to the control station device. The control station device then uses the measurement results acquired from each access point to estimate interference powers and interference occupancy rates from other access points in each access point, and thus can determine channels to be allocated to the respective access points. As described above, each access point according to the present embodiment only needs to stop the communication channel while received powers over the other channels are being acquired, which can reduce the period of time during which the communication channel is stopped. Thus, the wireless communication system according to the present embodiment can improve the communication efficiency.

Specifically, a period of time for measuring a received power only needs to be a period of time used when about 10 packets of received powers are averaged, and thus is one second when a beacon of an access point is transmitted at intervals of 100 milliseconds. In contrast, measurement of traffic volume to obtain a channel occupancy rate takes about 10 seconds. Thus, the wireless communication system according to the present embodiment can reduce the measuring time by a factor of about 10 in comparison with the case of stopping the communication channel to measure the traffic volume of the other channels.

### Modifications

In the first embodiment, the channel-allocation calculation unit 16 uses the interference matrix to allocate channels. Alternatively, the channel-allocation calculation unit 16 may use information other than the interference matrix to allocate channels.

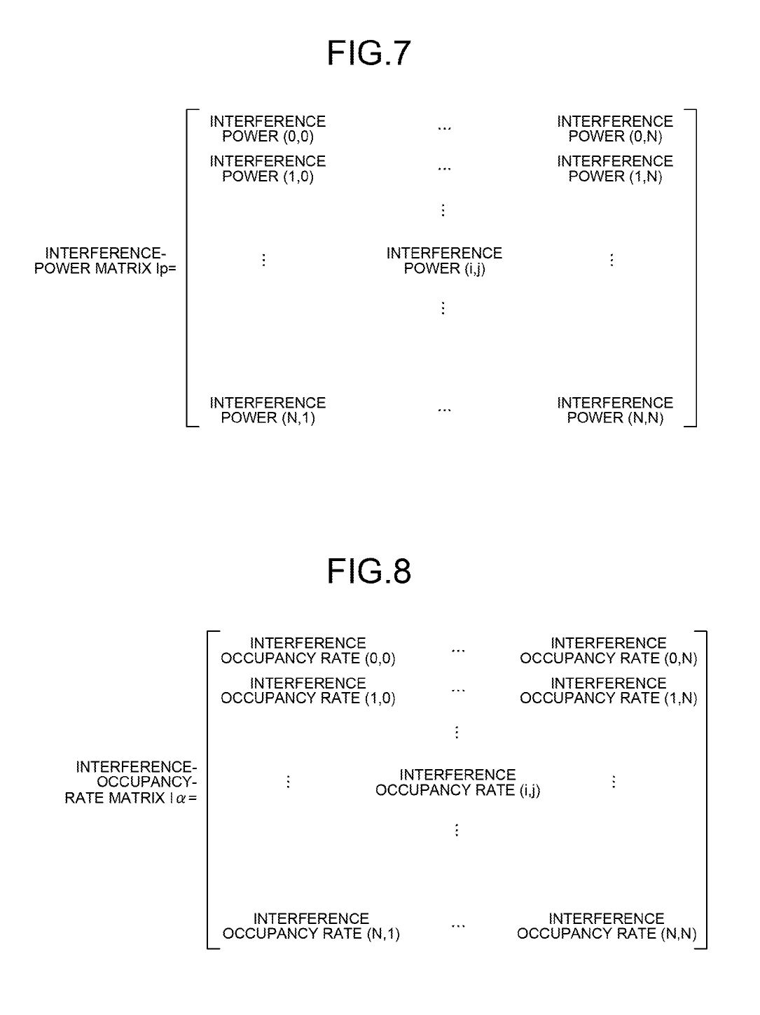

For example, using interference powers calculated by the interference-power calculation unit 13, the interference-matrix generation unit 15 can generate an interference-power matrix Ip depicted in FIG. 7. FIG. 7 is a diagram of one example of the interference-power matrix. The interference power (i, j) that is an ij component of the interference-power matrix Ip in FIG. 7 corresponds to an interference power from the access point #j in the access point #i calculated by the interference-power calculation unit 13.

Using interference occupancy rates calculated by the interference-occupancy-rate calculation unit 14, the interference-matrix generation unit 15 can generate an interference-occupancy-rate matrix Iα depicted in FIG. 8. FIG. 8 is a diagram of one example of the interference-occupancy-rate matrix. The interference occupancy rate (i, j) that is an ij component of the interference-occupancy-rate matrix Iα in FIG. 8 corresponds to an interference occupancy rate from the access point #j in the access point #i calculated by the interference-occupancy-rate calculation unit 14.

The interference-matrix generation unit 15 outputs the interference-power matrix Ip and the interference-occupancy-rate matrix Iα thus generated to the channel-allocation calculation unit 16.

The channel-allocation calculation unit 16 receives inputs of the interference-power matrix Ip and the interference-occupancy-rate matrix Iα from the interference-matrix generation unit 15. Using the interference-power matrix Ip and the interference-occupancy-rate matrix Iα, the channel-allocation calculation unit 16 determines channels to be allocated to the respective access points 20.

### Second Embodiment

The following describes a second embodiment. A control station device according to the present embodiment is different from that of the first embodiment in that noise components are arranged in diagonal components of the interference matrix. The control station device according to the present embodiment is also depicted in the block diagram of FIG. 3. In the following description, description of functions of the respective elements that are the same as those of the first embodiment is omitted.

When having detected a received power from a non-control-target access point that does not belong to the wireless communication system 1, the communication-channel received-power measurement unit 25 and the other-channel received-power measurement unit 27 of each access point 20 measure, for example, a received power of a beacon signal transmitted by the non-control-target access point. The communication-channel received-power measurement unit 25 and the other-channel received-power measurement unit 27 then transmit information on the measured received power from the non-control-target access point to the control station device 10 via the communication control unit 21.

The communication control unit 11 of the control station device 10 receives, from the access point 20, information on the received power from the non-control-target access point. The communication control unit 11 then causes the storage unit 12 to store therein the information on the received power from the non-control-target access point.

The interference-matrix generation unit 15 receives, from the interference-power calculation unit 13, inputs of interference powers from the other access points 20 in each access point 20. Furthermore, the interference-matrix generation unit 15 receives, from the interference-occupancy-rate calculation unit 14, inputs of interference occupancy rates from the other access points 20 in each access point 20. Using the interference powers and the interference occupancy rates thus acquired, the interference-matrix generation unit 15 generates an interference matrix. In this state, the interference power and the interference occupancy rate in each access point 20 from the access point itself are not handled, and accordingly the corresponding diagonal component of the interference matrix is blank.

Thus, the interference-matrix generation unit 15 acquires the information on the received power from the non-control-target access point in each access point 20 from the storage unit 12. Using the received power from the non-control-target access point, the interference-matrix generation unit 15 calculates an interference amount from the non-control-target access point in each access point 20. For example, the interference-matrix generation unit 15 sets the total of received powers from the non-control-target access point as the interference amount. The interference-matrix generation unit 15 then arranges the interference amount of the non-control-target access point in the corresponding diagonal component of the interference matrix. Subsequently, the interference-matrix generation unit 15 outputs the generated interference matrix to the channel-allocation calculation unit 16.

Herein, the interference amount from the non-control-target access point in each access point 20 can be considered as a noise component in each access point 20. In other words, the interference-matrix generation unit 15 arranges the noise component in each access point 20 as the corresponding diagonal component of the interference matrix.

In the present embodiment, the received power of a beacon signal transmitted by a non-control-target access point in each access point 20 is used as a noise component. However, other information may be used if the information can be used as a noise component in the access point 20.

As described above, the control station device according to the present embodiment determines channels to be allocated to the respective access points, using the interference matrix having diagonal components in which noise components in the respective access points are arranged. Consequently, channels can be allocated to the respective access points more appropriately in accordance with operational conditions.

### Hardware Configuration

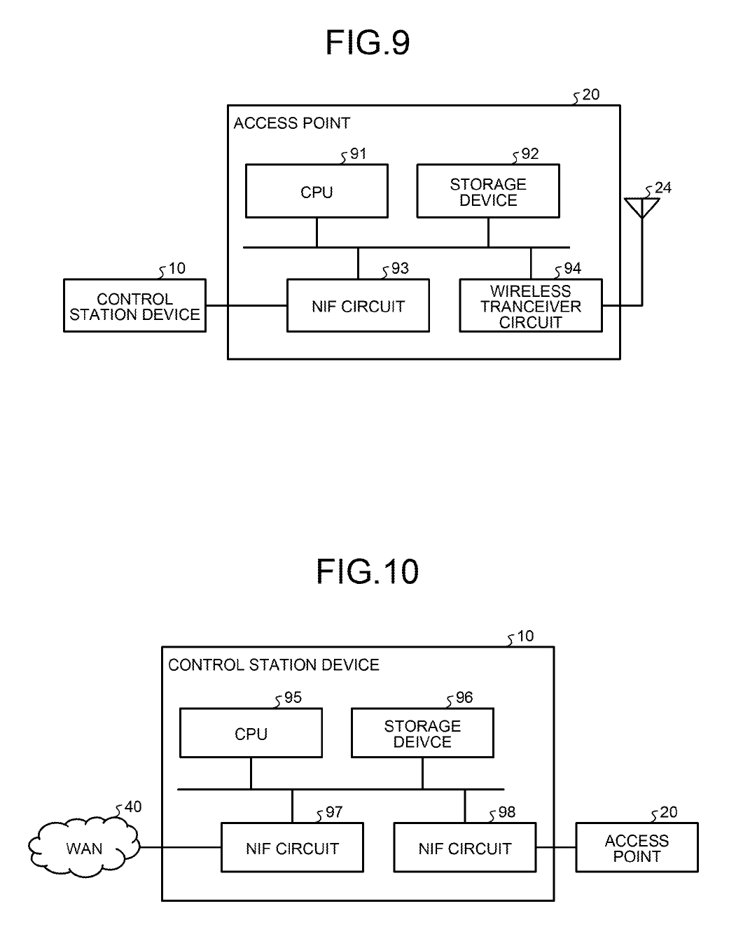

FIG. 9 is a hardware configuration diagram of each access point. As depicted in FIG. 9, each access point 20 includes a central processing unit (CPU) 91, a storage device 92, a network interface (NIF) circuit 93, and a wireless transceiver circuit 94.

The CPU 91 is connected to the storage device 92, the NIF circuit 93, and the wireless transceiver circuit 94 via a bus. The wireless transceiver circuit 94 is connected to the antenna 24.

The wireless transceiver circuit 94 implements the functions of the wireless communication unit 23, the communication-channel received-power measurement unit 25, the communication-channel channel-occupancy-rate measurement unit 26, and the other-channel received-power measurement unit 27 illustrated in FIG. 2.

The NIF circuit 93 is connected to the control station device 10. The NIF circuit 93 is a communication interface for communicating with the control station device 10.

The storage device 92 is a memory or a hard disk, for example. The storage device 92 stores therein various programs including a program for implementing the functions of the communication control unit 21 and the signal processing unit 22 illustrated in FIG. 2.

The CPU 91 and the storage device 92 implement the functions of the communication control unit 21 and the signal processing unit 22 illustrated in FIG. 2. For example, the CPU 91 reads and executes the various programs stored in the storage device 92, thereby implementing the functions of the communication control unit 21 and the signal processing unit 22 illustrated in FIG. 2.

FIG. 10 is a hardware configuration diagram of the control station device. As depicted in FIG. 10, the control station device 10 includes a CPU 95, a storage device 96, and NIF circuits 97 and 98. The CPU 95 is connected to the storage device 96 and the NIF circuits 97 and 98 via a bus.

The NIF circuit 97 is connected to the WAN 40. The NIF circuit 97 is a communication interface for communicating with the WAN 40. The NIF circuit 98 is connected to each access point 20. The NIF circuit 98 is a communication interface for communicating with the access point 20. The NIF circuits 97 and 98 implement the function of the communication control unit 11.

The storage device 96 is a memory or a hard disk, for example. The storage device 96 implements the function of the storage unit 12 illustrated in FIG. 3. Furthermore, the storage device 96 stores therein various programs including a program for implementing the functions of the interference-power calculation unit 13, the interference-occupancy-rate calculation unit 14, the interference-matrix generation unit 15, and the channel-allocation calculation unit 16.

The CPU 95 and the storage device 96 implement the functions of the interference-power calculation unit 13, the interference-occupancy-rate calculation unit 14, the interference-matrix generation unit 15, and the channel-allocation calculation unit 16 illustrated in FIG. 3. For example, the CPU 95 reads and executes the various programs stored in the storage device 96, thereby implementing the functions of the interference-power calculation unit 13, the interference-occupancy-rate calculation unit 14, the interference-matrix generation unit 15, and the channel-allocation calculation unit 16 illustrated in FIG. 3.

In the respective embodiments and the modifications above, a configuration has been described in which each access point 20 is connected to the WAN 40 via the control station device 10. However, a configuration other than this may be used. For example, each access point 20 may be configured to be connected to the WAN 40 without being routed via the control station device 10. Also in this case, the control station device 10 is connected to each access point 20, and determines and allocates a communication channel to each access point 20. Furthermore, any one of the access points 20 may have the function of the control station device 10.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising:
a plurality of base station devices; and
a wireless communication control device, wherein each of the base station devices comprises:
a channel-occupancy-rate measurement unit that measures a channel occupancy rate due to communication between the base station device itself and a terminal device connected to the base station device itself in a channel used for communication by the base station device itself;
a first received-power measurement unit that measures a first received power from a first other base station device that uses for communication the channel used for communication by the base station device itself among the base station devices and from a first terminal device connected to the first other base station device;
a second received-power measurement unit that measures a second received power from a second other base station device that uses for communication a channel other than the channel used for communication by the base station device itself among the base station devices and from a second terminal device connected to the second other base station device; and
a notification unit that notifies the wireless communication control device of the channel occupancy rate, the first received power, and the second received power, and
the wireless communication control device comprises an interference-information calculation unit that obtains an interference power and an interference occupancy rate between each pair among the base station devices, based on the channel occupancy rate, the first received power, and the second received power of which the notification unit of each of the base station devices has notified the wireless communication control device.

2. The wireless communication system according to claim 1, wherein the wireless communication control device further comprises a channel allocation unit that determines a channel to be used for communication by each of the base station devices, based on the interference power and the interference occupancy rate calculated by the interference-information calculation unit, and allocates the channel determined to each of the base station devices.

3. The wireless communication system according to claim 1, wherein
the wireless communication control device further comprises:
an interference-matrix generation unit that generates, for each of the base station devices, an interference matrix that represents influence of interference from the first other base station device, the first terminal device, the second other base station device, and the second terminal device, based on the interference power and the interference occupancy rate calculated by the interference-information calculation unit; and
a channel allocation unit that determines a channel to be used for communication by each of the base station devices, based on the interference matrix generated by the interference-matrix generation unit, and allocates the channel determined to each of the base station devices.

4. The wireless communication system according to claim 3, wherein the interference-matrix generation unit arranges, in a diagonal component of the interference matrix corresponding to each of the base station devices, a noise component in the base station device.

5. A base station device comprising:
a channel-occupancy-rate measurement unit that measures a channel occupancy rate due to communication between the base station device itself and a terminal device connected to the base station device itself in a channel used for communication by the base station device itself;
a first received-power measurement unit that measures a first received power from a first other base station device that uses for communication the channel used for communication by the base station device itself among a plurality of base station devices included by a wireless communication system to which the base station device itself belongs and from a first terminal device connected to the first other base station device;
a second received-power measurement unit that measures a second received power from a second other base station device that uses for communication a channel other than the channel used for communication by the base station device itself among the base station devices and from a second terminal device connected to the second other base station device; and
a notification unit that notifies the wireless communication control device of the channel occupancy rate, the first received power, and the second received power.

6. A wireless communication control device comprising:
an information receiving unit that
from each of a plurality of base station devices, each of the base station devices including: a channel-occupancy-rate measurement unit that measures a channel occupancy rate due to communication between the base station device itself and a terminal device connected to the base station device itself in a channel used for communication by the base station device itself; a first received-power measurement unit that measures a first received power from a first other base station device that uses for communication the channel used for communication by the base station device itself among a plurality of base station devices included by a wireless communication system to which the base station device itself belongs and from a first terminal device connected to the first other base station device; and a second received-power measurement unit that measures a second received power from a second other base station device that uses for communication a channel other than the channel used for communication by the base station device itself among the base station devices and from a second terminal device connected to the second other base station device,
receives the channel occupancy rate, the first received power, and the second received power; and
an interference-information calculation unit that obtains an interference power and an interference occupancy rate between each pair among the base station devices, based on the channel occupancy rate, the first received power, and the second received power received.

7. The wireless communication control device according to claim 6, further comprising a channel allocation unit that determines a channel to be used for communication by each of the base station devices, based on the interference power and the interference occupancy rate calculated by the interference-information calculation unit, and allocates the channel determined to each of the base station devices.

8. The wireless communication control device according to claim 6, further comprising:
an interference-matrix generation unit that generates, for each of the base station devices, an interference matrix that represents influence of interference from the first other base station device, the first terminal device, the second other base station device, and the second terminal device, based on the interference power and the interference occupancy rate calculated by the interference-information calculation unit; and
a channel allocation unit that determines a channel to be used for communication by each of the base station devices, based on the interference matrix generated by the interference-matrix generation unit, and allocates the channel determined to each of the base station devices.

9. The wireless communication control device according to claim 8, wherein the interference-matrix generation unit arranges, in a diagonal component of the interference matrix corresponding to each of the base station devices, a noise component in the base station device.

10. A wireless communication control method used in a wireless communication system including a plurality of base station devices and a wireless communication control device, the wireless communication control method comprising:
measuring, by each of the base station devices, a channel occupancy rate due to communication between the base station device itself and a terminal device connected to the base station device itself in a channel used for communication by the base station device itself;
measuring, by each of the base station devices, a first received power from a first other base station device that uses for communication the channel used for communication by the base station device itself among the base station devices and from a first terminal device connected to the first other base station device;
measuring, by each of the base station devices, a second received power from a second other base station device that uses for communication a channel other than the channel used for communication by the base station device itself among the base station devices and from a second terminal device connected to the second other base station device;
notifying, by each of the base station devices, the wireless communication control device of the channel occupancy rate, the first received power, and the second received power; and
obtaining, by the wireless communication control device, an interference power and an interference occupancy rate between each pair among the base station devices, based on the channel occupancy rate, the first received power, and the second received power of which each of the base station devices has notified the wireless communication control device.
